(19) United States
(12) Patent Application Publication
(10) Pub. No.: US 2018/0232784 A1
(43) Pub. Date: Aug. 16, 2018

(54) METHOD AND SYSTEM FOR REAL ESTATE VALUATION

(71) Applicant: MUNICIPAL PROPERTY ASSESSMENT CORPORATION, Pickering (CA)

(72) Inventors: Sujit Pal Singh JAGDEV, Pickering (CA); Christopher Paul DEVADASON, Pickering (CA); Salman Ashiqali SAYANY, Pickering (CA); Kyle Robert Joseph PALLANIK, Pickering (CA); James Kenneth ELLENS, Pickering (CA)

(73) Assignee: MUNICIPAL PROPERTY ASSESSMENT CORPORATION, Pickering, ON (CA)

(21) Appl. No.: 15/506,270

(22) PCT Filed: Aug. 26, 2015
(86) PCT No.: PCT/CA2015/050818

§ 371 Date: Feb. 24, 2017

(51) Int. Cl. G06Q 30/02; G06Q 50/16

(52) U.S. Cl. CPC G06Q 30/0278; G06Q 30/0201; G06Q 30/0205; G06Q 50/16

(57) ABSTRACT

A method for valuation in heterogeneous real property systems includes extracting, from a legacy property management system, a legacy system property data defined for a target real estate property from a legacy property management system, converting the legacy system property data from a legacy data format to a standardized format to obtain converted property data, and transmitting the converted property data to an orchestrator. The orchestrator queries a valuation tree with multiple property attributes from the converted property data to obtain a valuation model. The method further includes applying the valuation model to the converted property data to obtain multiple valuation results, generating a property value from valuation results, appending the property value to valuation results, and storing valuation results with a real estate property identifier for the target real estate property.

### CROSS-REFERENCE TO RELATED APPLICATIONS

This application claims priority under Article 8 of the Patent Cooperation Treaty to U.S. Patent Ser. No. 62/041,985 filed on Aug. 26, 2014, and entitled “Method and System for Valuation”. To the extent permissible under national patent laws, U.S. Patent Ser. No. 62/041,985 is incorporated herein by reference in its entirety.

### BACKGROUND

Real estate property, or real estate, is property that may include land, one or more buildings, or a portion of a building, minerals, and vegetation. Many different types of real estate property exist. For example, real estate property may be a farm, a house, a condominium, a ranch, undeveloped land, an office building and the land underneath, a warehouse and the land underneath, another type of real estate property, or any combination thereof. Real estate property has a value. The value is the amount that a market is willing to pay for the real estate property. When the real estate property is not being sold, then the value may be estimated for various purposes.

### SUMMARY

A method for valuation in heterogeneous real property systems includes extracting, from a legacy property management system, a legacy system property data defined for a target real estate property from a legacy property management system, converting the legacy system property data from a legacy data format to a standardized format to obtain converted property data, and transmitting the converted property data to an orchestrator. The orchestrator queries a valuation tree with multiple property attributes from the converted property data to obtain a valuation model. The method further includes applying the valuation model to the converted property data to obtain multiple valuation results, generating a property value from valuation results, appending the property value to valuation results, and storing valuation results with a real estate property identifier for the target real estate property.

A system for valuation in heterogeneous real property systems including a computer processor, a storage device storing a valuation tree including multiple valuation models, and an orchestrator executing on the computer processor. The orchestrator is for receiving converted property data for a target real estate property, querying the valuation tree with multiple property attributes from a converted property data to obtain a valuation model of valuation models, and transmitting the converted property data and the valuation model to an analytical model executor to obtain multiple valuation results. The orchestrator is further for transmitting valuation results to a value data repository interface for storing in a value data repository, receiving a link to valuation results, and transmitting the link to a legacy property management system.

A distributed computer system including multiple nodes, the nodes are configured to execute a method for valuation in heterogeneous real property systems. The method includes extracting, from a legacy property management system, a legacy system property data defined for a target real estate property from a legacy property management system, converting the legacy system property data from a legacy data format to a standardized format to obtain converted property data, and transmitting the converted property data to an orchestrator. The orchestrator queries a valuation tree with multiple property attributes from the converted property data to obtain a valuation model. The method further includes applying the valuation model to the converted property data to obtain multiple valuation results, generating a property value from valuation results, appending the property value to valuation results, and storing valuation results with a real estate property identifier for the target real estate property.

Other aspects of the invention will be apparent from the following description and the appended claims.

### BRIEF DESCRIPTION OF DRAWINGS

FIGS. 1 and 2 show schematic diagrams in accordance with one or more embodiments of the invention.

FIGS. 3, 4, 5, and 6 show flowcharts in accordance with one or more embodiments of the invention.

FIG. 7 shows an example in accordance with one or more embodiments of the invention.

FIG. 8 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to valuation in heterogeneous real property systems. In particular, one or more embodiments of the invention use legacy system property data from legacy property management systems into a current property valuation framework. The property valuation framework may use different valuation models with different data formatting requirements in order to value the property. Thus, the property valuation framework provides a technique for incorporating multiple disparate systems and models to provide valuation of property.

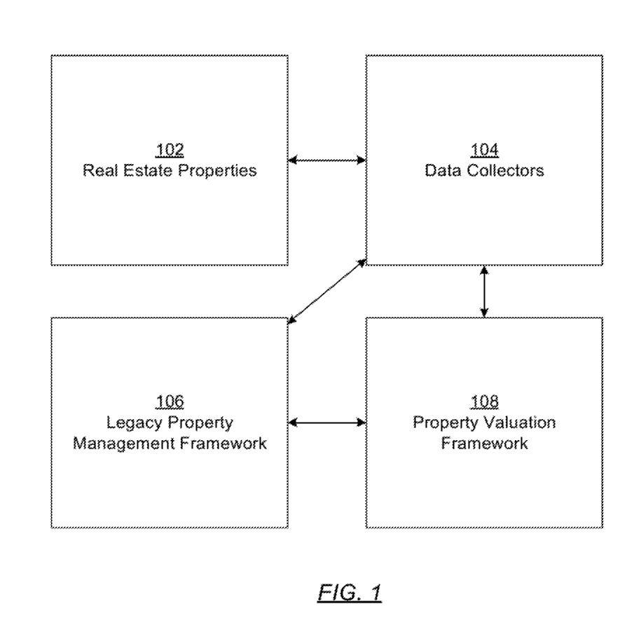

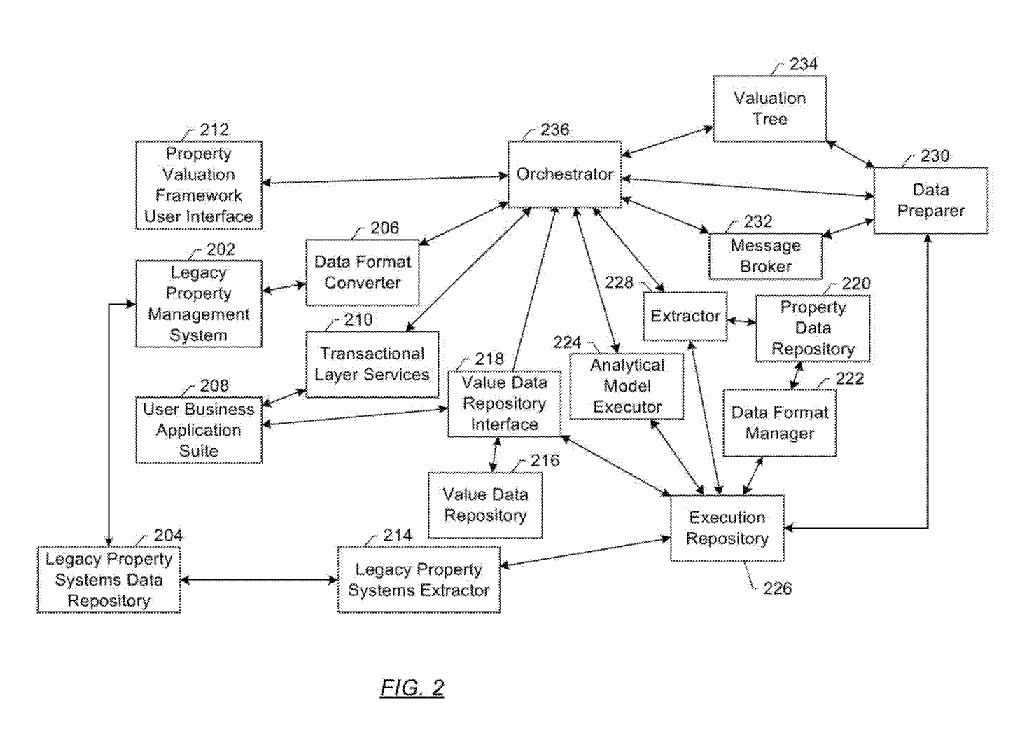

FIGS. 1 and 2 show schematic diagrams of a system in accordance with one or more embodiments of the invention. As shown in FIG. 1, the system may include real estate properties (102), data collectors (104), legacy property management frameworks (106), and property valuation framework (108). Each of these components is described below.

Real estate properties (102) are real properties that may include land, one or more buildings, or a portion of a building, minerals, and vegetation. For example, a real estate property may be a farm, a house, a condominium, a ranch, undeveloped land, an office building and the land underneath, a warehouse and the land underneath, another type of real estate property, or any combination thereof. A real estate property has a value. The value is the amount that a market is willing to pay for the real estate property. One or more embodiments provide a technique for valuation of real estate properties. The number of properties managed by one or more embodiments of the invention may be in the tens (e.g., for a small town) to millions or more (e.g., for a city, state, national region, or multiple country region).

The data collectors (104) include functionality to gather information about the real estate properties (102). The data collectors may include individuals and/or machines. For example, individuals may visit one or more of the real estate properties and record measurements and notes about the attributes of the property. The attributes of the property are any physical attributes describing the property and the environment in which the property is located that has the potential to affect the value of the property. For example, the attributes may include the number and size of each room, size and use type of property, amount of covered space, materials used to build property, current condition of property, defects in property, location of the property, whether the property is situated in a subdivision or in the middle of town, number of neighboring schools, and any other information that may affect the value of the property. By way of another example, individuals may identify attributes of the property from other individuals, building plans, and other reports with or without visiting the property. The individuals may submit the attribute information (e.g., measurements and notes) as property data to one or more legacy property management frameworks (106) and/or to the property valuation framework (108).

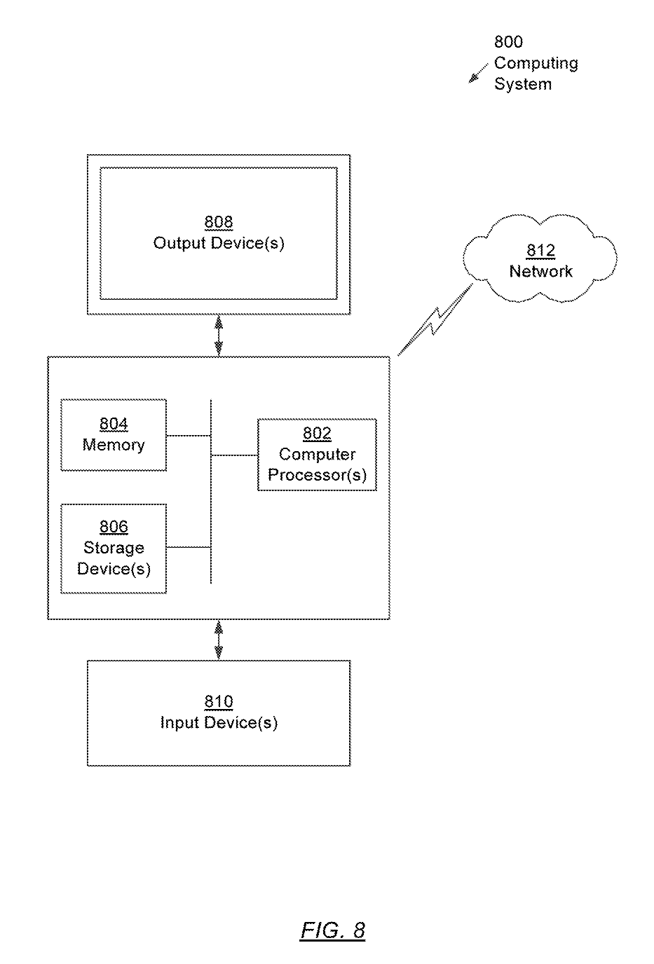

Similar to individuals, machines may also or alternatively be data collectors (104). For example, software executing on computing devices (e.g., the computing device shown in FIG. 8) may parse various reports and images of the property and extract the attributes of the property from the parsed reports and images. By way of another example, automated data collectors may be physically present at the property and gather attribute information from the property. In one or more embodiments of the invention, the machines may submit the attribute information as property data to the one or more legacy property management frameworks (106) and/or property valuation framework (108).

A legacy property management framework (106) may be directly or indirectly connected to one or more of the data collectors (104). For example, data collectors (104) may submit the attribute information to a terminal of the legacy property management framework, via a network, or using another technique. In some embodiments, the legacy property management framework may include one or more data collectors, such as when the data collectors are software and hardware that extracts property data from documents describing the property. In one or more embodiments of the invention, a legacy property management framework (106) is any preexisting system that manages property for a geographic region. For example, the geographic region may be an assessment jurisdiction, a province, a state, a city, etc. In other words, the legacy property management framework (106) is preexisting in that the legacy property management framework (106) exists and is used for the region prior to the property valuation framework being used for the region. The legacy property management framework (106) may include legacy hardware and software. For example, the legacy property management framework (106) may include proprietary data repository systems with proprietary data formats for storing property information. Example legacy property management frameworks (106) may include RealWare real estate accounting software, developed by RealWare, Inc., Integrated Property System developed by Municipal Property Assessment Corporation, and Source developed by Municipal Property Assessment Corporation.

In one or more embodiments of the invention, the property valuation framework (108) corresponds to an interconnection of multiple hardware and software components that together include functionality to value property using property data from disparate and heterogeneous property management systems. In one or more embodiments of the invention, the property valuation framework (108) includes functionality to operate in an individual property mode and in a batch mode. In the individual property mode, the property valuation framework (108) generates valuation information for a single real property, or a logical grouping of real properties that are valued as a single entity. In the batch mode (i.e., multiple property mode), the property valuation framework (108) includes functionality to process multiple properties at the same time with a single user request. For example, the batch mode may be to provide valuation information for each property in a geographic region. In one or more embodiments of the invention, the property valuation framework (108) is a server side system that includes functionality to value property.

FIG. 2 shows a schematic diagram of the property valuation framework with the legacy property management framework (i.e., legacy property management system (202), legacy property systems data repository (204)) in accordance with one or more embodiments of the invention. Each of the components of FIG. 2 is described below.

FIG. 2 shows various data repositories (e.g., legacy property systems data repository (204), value data repository (216), execution repository (226), and property data repository (220)). In one or more embodiments of the invention, a data repository, such as the data repositories shown in FIG. 2, is any type of storage unit and/or device (e.g., a file system, database, collection of tables, or any other storage mechanism) for storing data. Further, the data repository may include multiple different storage units and/or devices. The multiple different storage units and/or devices may or may not be of the same type or located at the same physical site. Further, as used herein, a data repository may include a valuation model, real estate property, or other item when the data repository includes a unique identifier and/or information about the item or includes the item directly.

Additionally, the various data repositories may have disparate mechanisms for storing and organizing data. Further, the data format may vary between data repositories. The variation may span the different types of data formats. For example, the type of data format may refer to the data type (e.g., using float, integer, double, string, or other organizations of “1's” and “0's” to represent a particular value), the recording format that defines the placement of data on a storage medium (e.g., positions of vectors), the file format (e.g., the ordering of bits in a file), the content format (e.g., how the values are encoded, such that the attribute and the corresponding value may be identified from the encoding), and any other type of data format. With respect to the content format, different systems may have different attribute names for the same attributes, and some systems may use the position of the value in the data repository to identify each value's corresponding attribute. For example, consider the scenario in which a property has an attribute of having 7 rooms. In the example, different systems may represent the attribute in different manners, such as (1) having an attribute name and value pair of “num_rooms=7,” where 7 is a String; (2) having an attribute name and value pair of “rms=7,” where 7 is an integer; (3) having just the value “7” in a particular position in the record for the property. Further, some systems may have the property data for a property as a record in a database, another system may have the property data as a separate file, and another system may have the record in a particular spreadsheet application. Thus, each of the types of data formatting may vary between and amongst the legacy property management systems and the property valuation framework.

Continuing with FIG. 2, as discuss above, a property management framework may include a legacy property management system (202) and a legacy system property data repository (204). The legacy property management system (202) is the hardware and/or software that includes functionality to manage real estate properties. For example, the legacy property management system may include functionality to perform valuations on property. Further, the legacy property management system may include functionality to perform various functions based on the valuation of real estate property. For example, the functions may be to generate a tax statement, make a recommendation whether to sell the property, modify a tax amount, provide information on comparably valued properties, and perform other functions. The legacy system property data repository (204) is a data repository for storing legacy system property data. The legacy system property data may be stored in virtually any manner in the legacy property systems data repository (204) as discussed above. Multiple legacy property management frameworks may exist, where each legacy property management framework has a distinct and individual data format.

In one or more embodiments of the invention, the data format converter (206) includes functionality to retrieve property data from a legacy system and convert the data format of the property data to a standardized format. In other words, the data format converter includes functionality to identify each type of data format of the property data, extract the values and corresponding attribute names based on the type from the legacy property system data repository, and store the extracted values and corresponding attribute names in a standardized format. Although not shown in FIG. 2, the data format converter may be connected directly to the legacy property systems data repository (204), such as where the data format converter extracts the property data directly from the legacy property systems data repository in the property data's native (i.e., legacy) format. In some embodiments, the data format converter (206) includes functionality to receive an intermediate representation of the data that is exported by the legacy property management system (202). For example, the legacy property management system (202) may be configured to export the property data, and, in exporting, change the data format from the legacy data format to an intermediate format. In one or more embodiments of the invention, regardless how the data is obtained, the standardized format is a data format that is common across all property data for representing the attributes of the property to the data preparer. In other words, the standardized format is independent of the origin of the data, such that the origin is indeterminable from the standardized format.

In one or more embodiments of the invention, the user business application suite (208) is a suite of one or more applications that support a user business. For example, the user business application suite (208) may include functionality to generate and mail tax invoices to property owners based on the valuation information, manage tax payments based on the property values, manage petitions and hearings to reconsider values, obtain and display pictures and locations of comparable properties, support real estate sales and purchasing (e.g., provide software functionality for creating a sales listing, generating contracts, communicating an offer, and managing other aspects of a real estate sale and purchase), provide frontend support for appraisal, and/or perform other actions based on the real estate valuation. The user application business suite may be part of the property valuation framework or separate from the property valuation framework. In one or more embodiments of the invention, the user business application suite (208) may execute on the same or different computer system than the property valuation framework. Multiple different user business applications may exist in the user business application suite. The user business application suite may be all or partially interoperable or disparate systems. In other words, heterogeneity may exist in the computing devices and data formats of the user business application suite.

The transactional layer services (210) include functionality to interact with the user business application suite (208) in accordance with one or more embodiments of the invention. In at least some embodiments, the transactional layer services (210) provide stateless services that serve as an application programming interface (API) for the user business application suite. The transactional layer services may also serve as a data API and transactional layer in and write through cache in front of the property data repository (232). For example, the transactional layer services (210) may include functionality to perform data merging of the legacy system property data from different legacy property management systems. Although not shown in FIG. 2, the transactional layer services may include a data repository for storing a current property record being processed.

In one or more embodiments of the invention, the property valuation framework user interface (212) is a collection of user interface widgets that include functionality to interact with a user. For example, the user interface widgets may include drop down boxes, fields, scroll bars, buttons, text boxes, check boxes, windows, panels, tabs, and other widgets that provide information to and receive information from users. In one or more embodiments of the invention, the property valuation framework user interface (212) is a frontend for the property valuation framework. In some embodiments, the property valuation framework user interface (212) is a frontend portion of a web application that is executable in a web browser. In such a scenario, communication with the backend of the property valuation framework may be performed using hypertext transfer protocol requests, or other such protocol requests. For example, the property valuation framework user interface may include functionality to receive selection criteria or a property identifier from a user via the user interface widgets, and instigate valuation of the property using the property valuation framework.

The property valuation framework user interface (212) may further include functionality to display valuation information. The valuation information may be displayed, for example, in an interactive report that shows the property value, charts describing the values assigned to different attributes of the property, reasons for the property value, a breakdown of the different models used to value the property, and other information. For multiple property valuation mode, the property valuation framework user interface (212) may include functionality to display reports describing the values, trends in values, and other information. The output from the property valuation framework user interface may be interactive in that a user may switch between displaying the valuation information in various different levels of granularity. For example, for a single property, the whole property value may be displayed, and, when a user selects a user interface widget, the proper value for the different components may be displayed. For multiple properties in an example, a report that spans the entire region may be displayed, and a user may interact with the property valuation framework user interface to view different reports for different sub-regions. Alternatively or additionally, the various valuation information may be displayed in the user business application suite.

Additionally, the property valuation framework user interface (212) may include functionality to receive configuration parameters, data preparation code, valuation models, and the valuation tree, and/or identifiers of storage locations having all or part of configuration parameters, data preparation code, valuation models, and the valuation tree.

Continuing with FIG. 2, the legacy property systems extractor (214) includes hardware, software, firmware, or any combination thereof to implement an extract, transform, and load process. The legacy property systems extractor (214) may include functionality to extract property data from a legacy property systems data repository (204), transform the property data to the standardized format, and store the property data in the property data repository (220) directly or via the execution repository (226). In one or more embodiments of the invention, the legacy property systems extractor (214) may include functionality to perform batch processing of the property data. In other words, the legacy property systems extractor may include functionality to receive a command with an identifier of the location of the property data in the legacy data format, information about the legacy data format, and extract the property data autonomously without further interaction from other components of the process valuation framework.

In one or more embodiments of the invention, the property data repository (220) includes functionality to store property data that is in a standardized format, where each property is stored as a property record. In one or more embodiments of the invention, the property record in the property data repository (220) provides a snapshot of the attributes of the property at a particular point in time. In other words, because the attributes of the property may change with remodeling, building new buildings, and deterioration, the valuation reflects an estimate of the property value at a particular moment in time. A single property may have multiple corresponding property records, whereby the multiple property records are for different times. The physical storage of the property records may vary, for example, separate and distinct property records may be maintained for each moment in time of the property. By way of another example, at least one complete property record may exist for the property, and one or more subsequent property records may be stored by storing a change history from the complete property record.

In one or more embodiments of the invention, the data format manager (222) corresponds to hardware, software, firmware, or any combination thereof that includes functionality to schedule the legacy property systems extractor (214) to execute. The data format manager (222) may further include functionality to transform the property data from the legacy property systems extractor (214) into the standardized format. For example, the legacy property systems extractor may output an intermediate format, which is translated by the data format manager (222) into property records for storage in the property data repository (220).

In one or more embodiments of the invention, the value data repository (216) includes functionality to store the valuation information. In one or more embodiments of the invention, the valuation information may include the total value, attributes and attribute values of the property at the time of the valuation, the valuation models used to value the property and the corresponding values, and other information.

In one or more embodiments of the invention, the value data repository interface (218) is hardware, software, firmware, or any combination thereof that is an interface for interacting with the value data repository (216). In particular, the value data repository interface (218) may include functionality to obtain valuation information from the value data repository (216), and populate the value data repository (216). The value data repository interface (218) may further include functionality to process the valuation information and append data to the valuation information.

In one or more embodiments of the invention, the analytical model executor (224) corresponds to hardware, software, firmware, or any combination thereof that includes functionality to execute valuation models on property data. In particular, the analytical model executor (224) includes functionality to receive the valuation model and execute the valuation model on a set of property data. In one or more embodiments of the invention, the analytical model executor (224) may operate on a single property and valuation model basis. In other words, the analytical model executor may receive the property data for a single property and a valuation model identifier and execute on the single property to generate the valuation results, describing the property valuation. Thus, the analytical model executor may be stateless and operate on a sub job basis that includes a valuation model and a property.

In one or more embodiments of the invention, the execution repository (226) includes functionality to store application scripts, execution files, delta extracts and other data files. The execution repository (226) may be a staging area for legacy property systems extractor and data creation processes.

In one or more embodiments of the invention, the extractor (228) corresponds to hardware, software, firmware, or any combination thereof that includes functionality to extract property data from the property data repository (220). In one or more embodiments of the invention, the extractor (228) may be a stateless service.

In one or more embodiments of the invention, the data preparer (230) corresponds to hardware, software, firmware, or any combination thereof that includes functionality execute data preparation code to prepare data for a particular valuation model. Specifically, each valuation model may have different formatting or portion of property data required in order to use the valuation model. The data preparer (230) includes functionality to execute the data preparation code to prepare property data for a particular property for the corresponding valuation model. For example, the data preparation code may be a script and the data preparer an interpreter. By way of another example, the data preparation code may be a compiled program.

In one or more embodiments of the invention, the message broker (232) is hardware, software, firmware or any combination thereof that includes functionality to decouple and maintain work queues across multiple physical nodes (e.g., computing systems). A queue is an ordered list of jobs, from which a job may be added to the end and removed from the beginning. For example, the message broker (232) may provide a queue from which each component processes individual jobs in the queue. Thus, for example, the data preparer (230) may have a separate entry in the queue for each job defined by a pair of property data and data preparation code to apply to the property data. The data preparer (230) may then continually retrieve each job from the corresponding queue in the message broker (232). The message broker (232) may provide similar queues for other components of the system.

In one or more embodiments of the invention, the valuation tree (234) is a tree that maintains a mapping between property attributes, valuation models, and data preparation code. In particular, each valuation model has a corresponding data preparation code specified in the valuation tree. The valuation tree (234) further maps a set of property attributes to one or more valuation models. The property attributes may be a subset of attributes of a property. For example, the valuation tree may map residential real estate property to a first valuation model, undeveloped farmland to a second valuation model, warehouses to another valuation model, and so forth. In the example, additional attributes besides property type may be in the set of attributes mapped, such as size, sub-region of the geographic region, whether the exterior walls are owned, and other property attributes. By way of an example, the primary nodes of the valuation tree may be the base year specific valuation models, each of which has associated child nodes for valuation type, locational neighborhood, regional neighborhoods, property type(s), structure type(s), component type(s) and data preparation code.

In one or more embodiments of the invention, the orchestrator (236) is hardware, software, firmware, or any combination thereof that includes functionality to orchestrate or manage the flow of data through various stages of processing. The orchestrator (236) may include functionality to manage the flow in a single property mode and multiple property mode. Further, the orchestrator may operate in a stateless technique through the execution of jobs managed by the message broker.

In one or more embodiments of the invention, the connections between the components of FIG. 2 may be direct or indirect, may be stateless (e.g., using Representational State Transfer (REST)), through a network (e.g., wide area or local area network), and/or through physical interconnect. Other connection mechanisms may be used without departing from the scope of the invention.

While FIGS. 1 and 2 show a configuration of components, other configurations may be used without departing from the scope of the invention. For example, various components may be combined to create a single component. As another example, the functionality performed by a single component may be performed by two or more components.

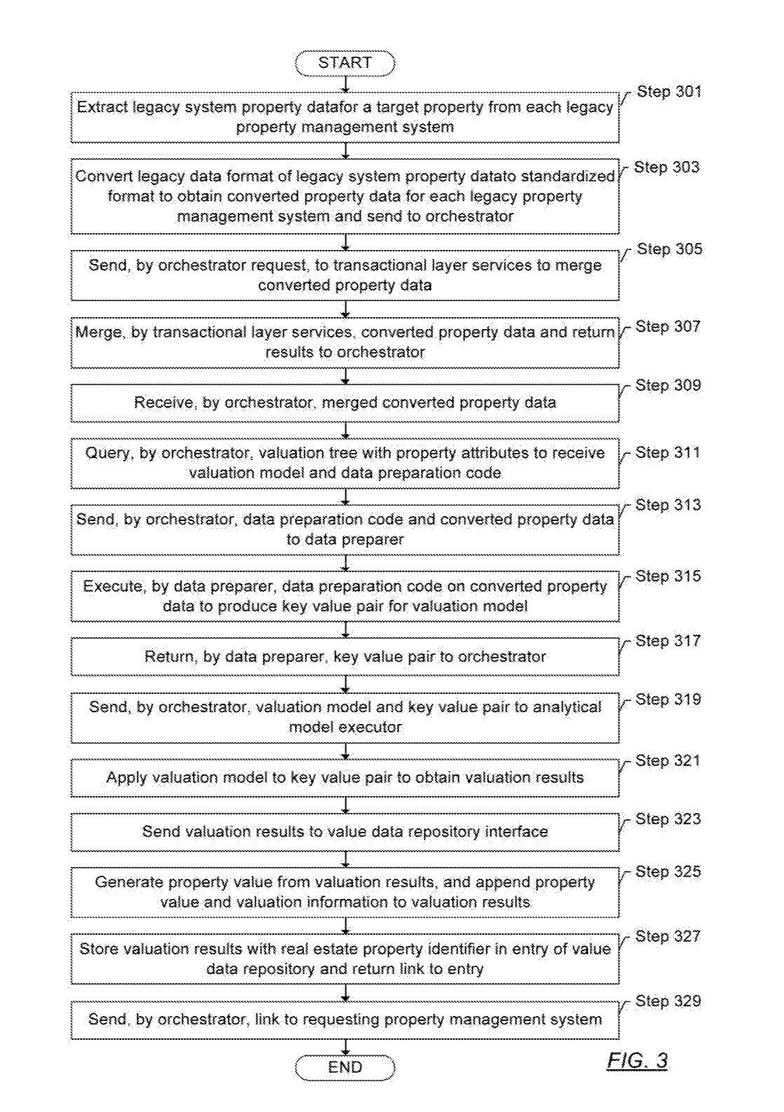

FIGS. 3, 4, 5, and 6 show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

FIG. 3 shows a flowchart for single execution mode of a single property in accordance with one or more embodiments of the invention. For example, the steps of FIG. 3 may be triggered, for example, by a user or machine requesting a valuation of a particular real estate property. For example, the request may be via the legacy property management system requesting valuation of the property, the property valuation framework user interface, or the user business application suite. In particular, a unique identifier of the property is specified, such as through the user interface or by a user business application. The unique identifier may be an address of the property, a tax code for the property, a collection of attributes of the property that together uniquely identify the property or any other unique identifier the property. For the purposes of FIG. 3, consider the scenario in which at least some of the property data is not stored in the property data repository.

In Step 301, legacy system property data is extracted for a target property from each legacy property management system in accordance with one or more embodiments of the invention. In one or more embodiments of the invention, the legacy system property data is transmitted from the legacy property management system to the data format converter. The legacy property management system may obtain the legacy system property data from the legacy system property data repository. Alternatively, the data format converter may directly extract the legacy system property data.

In Step 303, the legacy data format of the legacy system property data is converted to a standardized format to obtain converted property data for each legacy property management system. In one or more embodiments of the invention, the conversion may be performed using a predefined mapping between the legacy data format and standardized format. In particular, for each attribute in the standardized format, the mapping may be accessed to identify the corresponding attribute value in the legacy data format. Any data type translations are performed to put the attribute value in the data type format of the standardized data format. In one or more embodiments of the invention, once converted, the converted property data may be sent to the orchestrator.

If the orchestrator receives converted property data from multiple legacy property management systems, the orchestrator may initiate a merging of the property data. In such a scenario, in Step 305, the orchestrator sends a request to merge the converted property data to the transactional layer services. The request may include the converted property data from each legacy system property data management system. Alternatively, the request may include a link to a storage location having the converted property data. A link as used herein is any unique identifier of a particular location. In one or more embodiments of the invention, the request may be sent as a network server request, a remote procedural call request, or any other type of request from one component to another. Further, in one or more embodiments, the request may comply with REST.

In one or more embodiments of the invention, in Step 307, the transaction layer services merge the converted property data and return the result to the orchestrator. Merging the converted property data may include combining the property data corresponding to different attributes, removing redundant attribute and attribute value pairs, and selecting an attribute value according to a pre-defined set of rules in the case of inconsistencies between legacy system property data.

In Step 309, the orchestrator receives the results of the merged converted property data. For example, the orchestrator may receive a file having the merged converted property data. By way of another example, the merged converted property data may be stored in the execution repository and a link may be transmitted to the orchestrator.

In Step 311, a valuation tree is queried with property attributes to receive a valuation model and data preparation code in accordance with one or more embodiments of the invention. In one or more embodiments of the invention, the valuation tree is queried by the data preparer. In other embodiments, the valuation tree is queried by the orchestrator and the results passed to the data preparer. In one or more embodiments of the invention, the property attributes are only a strict subset of the property attributes of the system. For example, the property attributes may be selected (e.g., by data preparer or the orchestrator) based on a predefined set of rules. In particular, the predefined set of rules may specify to send only the property type, the relative size, and the use of the property to the valuation tree. Other attribute values may be defined in the predefined set of rules and sent accordingly without departing from the scope of the invention. In some embodiments, the predefined set of rules may specify to query the valuation tree with all attributes of the real estate property.

A lookup in the valuation tree may be performed as follows. Each node in the valuation tree may be a conditional node that represents a condition dependent on a value of an attribute of the property. Thus, starting with a root node, a determination is made as to whether an attribute value exists in the property that maps to a path to one of the child nodes. For example, the root node may be a condition that is dependent on property type, and the path selected may be the path to the residence child node where the attribute value of the property is a residence. The steps may iteratively or recursively repeat for the condition of the child node to go to the next child node. When the system traverses to a leaf node, the leaf node may specify the valuation model and the data preparation code. Because each child node selected is based on the attribute values of the real estate property, the leaf node selected is the node that particularly matches the real estate property.

In Step 313, the orchestrator sends the data preparation code and the converted target property data to the data preparer in accordance with one or more embodiments of the invention. In one or more embodiments, in the single property execution mode, the orchestrator sends the data preparation code and the converted property data directly to the data preparer. Sending the data preparation code and/or the target property data may include sending the particular instructions or the target property data (e.g., in a body of one or more packets) or sending a unique identifier or link to the data preparation code and/or target property data, such as a link or unique identifier to the data preparation code and converted target property data in the execution repository. Alternatively, the data preparer may obtain the data preparation code directly from the valuation tree and obtain the converted target property data.

In Step 315, the data preparer executes the data preparation code on the converted target property data to produce a key value pair for the valuation model in accordance with one or more embodiments of the invention. The key value pair is specific to the valuation mode. In other words, the key value pair is in accordance with the requirements of the valuation model. Generating the key value pair may include executing or interpreting the data valuation code using the converted property data as input.

In Step 317, the data preparer may return the results to the orchestrator. In other words, the data preparer transfers the key value pairs for the property data to the orchestrator. In one or more embodiments of the invention, the data preparer may store the key value pairs in the execution repository and transfer a link to the orchestrator. In other embodiments, the data preparer may transfer the actual key value pairs to the orchestrator.

In Step 319, the orchestrator sends the valuation model and the key value pairs to the analytical model executor in accordance with one or more embodiments of the invention. Sending the valuation model and/or the key value pairs may include directly sending the valuation model or the key value pairs (e.g., in a body of one or more packets) or sending a unique identifier or link to the valuation model and/or the key value pairs, such as a link or unique identifier to the valuation model and/or the key value pairs in the execution repository.

In Step 321, the valuation model is applied to the key value pair to obtain valuation results in accordance with one or more embodiments of the invention. In one or more embodiments of the invention, the valuation model may specify a mathematical function having constants and variables, where the variables are populated from values using the key value pairs. Thus, using the key value pairs, where the key maps to a variable in the mathematical function and the value is used as the value of the variable, the mathematical function is solved to obtain a valuation result. The valuation results may specify the estimated value for the valuation model and the key value pairs to calculate the estimated value. New valuation models may be added to the system by defining the new valuation models and the data preparation code for the new valuation models and storing the data preparation code and the valuation model in the execution repository. Further, a mapping between the valuation model and the property attributes may be stored in the valuation tree.

In one or more embodiments of the invention, the valuation tree may return multiple valuation models and multiple corresponding data preparation codes. In such a scenario, Steps 313-321 may be repeated for each valuation model to generate multiple valuation results. The analytical model executor or the orchestrator may combine the valuation results into a single record.

In Step 323, the valuation results are sent to the value data repository interface in accordance with one or more embodiments of the invention. As discussed above, the valuation results may be sent directly or indirectly to the value data repository interface.

In Step 325, a property value is generated from the valuation results. The property value and valuation information is appended to the valuation results in accordance with one or more embodiments of the invention. In one or more embodiments of the invention, the value data repository user interface may generate a total property value, and a rounded property value. The total property value and rounded property value may be appended, with information uniquely describing the valuation model to the valuation results.

In Step 327, valuation results are stored with the real estate property identifier in an entry of the value data repository and a link is returned to the entry in accordance with one or more embodiments of the invention. In particular, the link may be returned to the orchestrator. In Step 329, the orchestrator sends the link to the requesting property management system in accordance with one or more embodiments of the invention. For example, the orchestrator may send the link to the property valuation framework user interface in accordance with one or more embodiments of the invention. The property valuation framework user interface may use the link to generate a dynamic report and display the dynamic report in the user interface. As another example, the legacy property management system or user business application suite may use the valuation results to perform a function, such as generate and transmit tax reports, perform sales, and perform other actions.

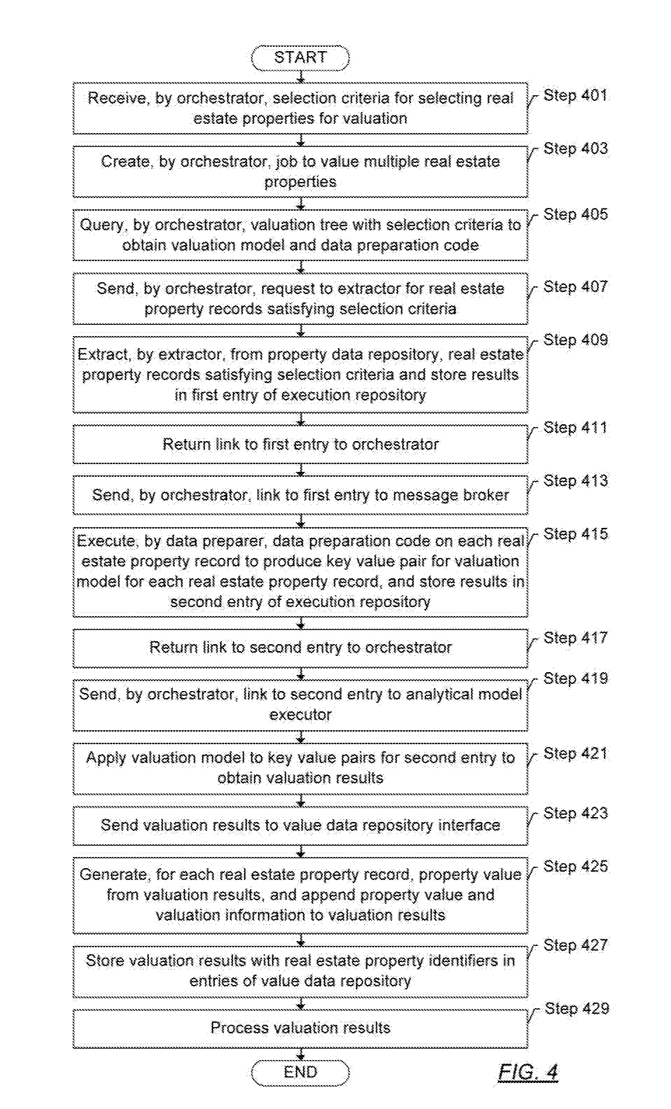

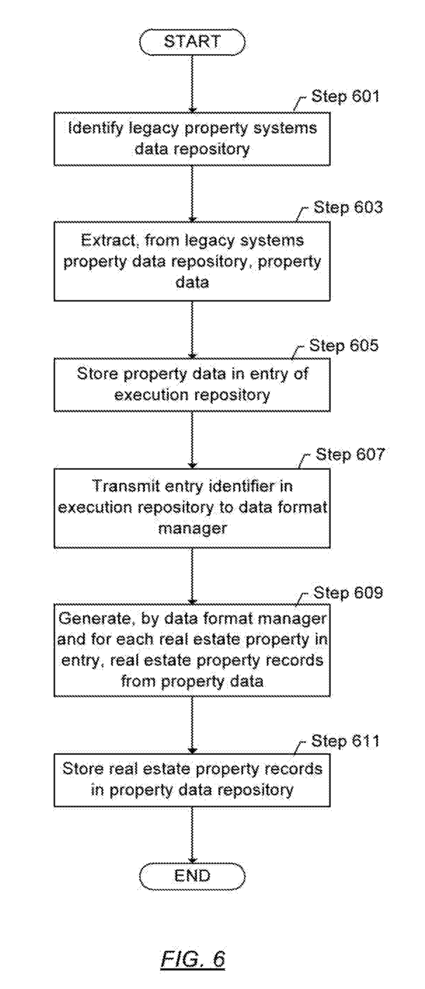

FIG. 4 shows a flowchart for multiple property execution in accordance with one or more embodiments of the invention. In the embodiment shown in FIG. 4, consider the scenario in which the property data is imported from the legacy data format to the standardized format and stored as individual property records in the data repository. If the property data is not imported, the steps 301-309 of FIG. 3 may be performed or all steps of FIG. 6 may be performed to transform and import the property data in the standardized format.

Continuing with FIG. 4, in Step 401, the orchestrator receives selection criteria for selecting real estate properties for valuation in accordance with one or more embodiments of the invention. For example, the selection criteria may be submitted by a user through a user interface. The selection criteria specifies a set of one or more attribute values for a set of real property. For example, if the user wants to obtain valuation results for each single family house in the city, the user may submit selection criteria that specifies single family house and the geographic limitations of the city.

In Step 403, the orchestrator creates a job to value multiple real estate properties in accordance with one or more embodiments of the invention. In one or more embodiments, the job provides tracking information for the request. For example, the job may store tracking information for the request, various links, and other information.

In Step 405, the orchestrator queries the valuation tree with selection criteria to obtain one or more valuation models and data preparation code in accordance with one or more embodiments of the invention. Step 405 may be performed in a same or similar manner to Step 311 in FIG. 3. However, in Step 405, the attribute values in the selection criteria is sent and used to traverse the valuation tree in accordance with one or more embodiments of the invention. In one or more embodiments, the results of querying the valuation tree with the selection criteria is a set of valuation models and data preparation codes that are applicable to all real estate properties matching the selection criteria in accordance with one or more embodiments of the invention.

In Step 407, the orchestrator sends a request to the extractor for real estate property records satisfying the selection criteria in accordance with one or more embodiments of the invention. The request may be transmitted as a procedure call, a remote procedure call, a server request or using any other request transmission mechanism. In Step 409, the extractor extracts real estate property records from the property data repository that satisfy the selection criteria and stores the records in a first entry of the execution repository. The extractor may query the property data repository for the entire records or for identifiers of each record satisfying the selection criteria. Further, the extractor may store the entire records or only the identifiers in an entry of the execution repository. In other words, the entry relates the records to each other as being for the same job. In Step 411, a link to the first entry is returned to the orchestrator.

In Step 413, the orchestrator sends the link to the first entry to the message broker in accordance with one or more embodiments of the invention. The message broker may then coordinate with the data preparer to process each entry. For example, the message broker may create a processing queue, where each entry in the processing queue is for a single property record. The message broker may then send the entries in the queue, one at a time, to the data preparer. Alternatively or additionally, the data preparer may include functionality to process in batch mode and prepare the each property record for valuation.

In Step 415, the data preparer executes data preparation code on each real estate property record to produce key value pair for valuation model for each real estate property record. The data preparer stores results in second entry of execution repository. In other words, for each valuation model returned by the valuation tree and each real estate property record in the first entry, the data preparer creates a key value pair representation of the real estate property record that is specific to the valuation model. Creating the key value pairs may be performed as discussed above with reference to Step 315 of FIG. 3. The data preparer may store the results, with the key value pairs for each valuation model and each real estate property record, in the second entry of the execution repository. In Step 417, the data preparer may return a link to the second entry to the orchestrator.

In Step 419, the orchestrator sends the link to the second entry to the analytical model executor in accordance with one or more embodiments of the invention. In one or more embodiments of the invention, the link to the second entry may include a job request requesting that the analytical model executor execute the corresponding valuation model on each set of key value pairs in the second entry, whereby a set corresponds to a distinct property record prepared for the valuation model.

In Step 421, the analytical model executor applies the valuation model to the set of key value pairs to obtain valuation results in accordance with one or more embodiments of the invention. In other words, because the second entry maintains the key value pairs for each property record individually, the analytical model executor applies the valuation model(s) separately to each set of key value pairs, whereby the set corresponds to a particular real estate property. Applying the valuation model may be performed in a same or similar manner discussed above with reference to Step 321 of FIG. 3.

In Step 423, the valuation results are sent to the value data repository interface in accordance with one or more embodiments of the invention. Step 423 may be performed in a same or similar manner discussed above with reference to Step 323 of FIG. 3.

In Step 425, for each real estate property record, property value is generated from valuation results, and appended with valuation information to the valuation results. Step 425 may be performed in a same or similar manner discussed above with reference to Step 325 of FIG. 3.

In Step 427, the value data repository interface stores the valuation results with real estate property identifier in entry of value data repository. Step 427 may be performed in a same or similar manner discussed above with reference to Step 327 of FIG. 3. The value data repository interface may or may not return a link to the entries in the value data repository.

In Step 429, the valuation results are processed in accordance with one or more embodiments of the invention. For example, the user business application suite may process the valuation results to perform a function, the property valuation framework user interface may display a report with the valuation results, and other processing may be performed. In some embodiments, merged property values are stored in transactional layer services. Step 429 may be performed in a same or similar manner discussed above with reference to Step 329 of FIG. 3.

Although not shown in FIGS. 3 and 4, in some embodiments, after the valuation results are obtained from the analytical model executor, the orchestrator issues a call to the data preparer with the valuation results. The data preparer may apply a prioritization to the valuation, add individual or property level adjustments (e.g., to give a discount based on attributes of the property or owner), partition property components, and return the results of the data preparer processing to the orchestrator for storage through the valuation repository interface in the valuation repository.

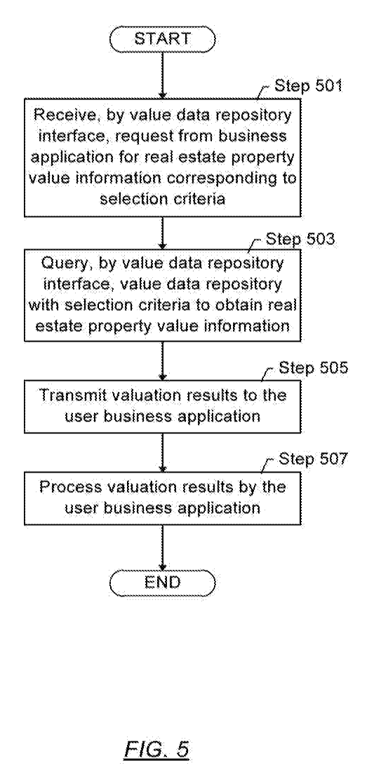

FIG. 5 shows a flowchart for accessing the valuation results after the real estate valuation results are generated and stored in accordance with one or more embodiments of the invention. In Step 501, the value data repository interface receives a request from business application for real estate property value information corresponding to selection criteria in accordance with one or more embodiments of the invention. Alternatively, the request may be received from the property valuation framework user interface or from the legacy property management system.

In Step 503, by value data repository interface queries the value data repository with selection criteria to obtain real estate property value information. In other words, the value data repository interface sends a query to the value data repository with the selection criteria and receives a response. The response includes, for each real estate property matching the selection criteria, valuation results of the real estate property in accordance with one or more embodiments of the invention.

In Step 505, the valuation results are transmitted to the user business application or any other requester (e.g., the property valuation framework user interface) in accordance with one or more embodiments of the invention. Thereafter, the valuation results may be processed by the requester in Step 507. Processing the valuation results may be performed as discussed above.

FIG. 6 shows a flowchart for performing data synchronization between the legacy system property data repository and the property data repository in accordance with one or more embodiments of the invention. In Step 601, the legacy property systems data repository is identified in accordance with one or more embodiments of the invention. In particular, the data format manager may schedule the collection and synchronization of data from the legacy property systems data repository. Thus, a company may continue to use the legacy property systems data repository to store the data. In some embodiments, synchronization may be triggered by a new legacy property systems data repository being connected to the valuation framework. Additionally or alternatively, the trigger may be based on a schedule, such as a nightly synchronization.

In Step 603, the property data is extracted from the legacy property systems data repository in accordance with one or more embodiments of the invention. In other words, each property record is separately identified and individually processed to not intermingle data from multiple records. Records for multiple properties or for the same property spanning a period of time may be batch processed together.

In Step 605, the property data is stored in an entry of the execution repository in accordance with one or more embodiments of the invention. Further, in Step 607, an entry identifier that identifies the entry specifying the property data is transmitted to the data format manager in accordance with one or more embodiments of the invention.

In Step 609, data format manager generates, for each real estate property in the entry of the execution repository, a real estate property record from the stored property data in accordance with one or more embodiments of the invention. In other words, from the execution repository, the data format manager starts processing the property data. Processing the records may include converting the records from the legacy data format to the standardized format. The conversion may be performed in a same or similar manner discussed above with reference to Step 303. Alternatively, the conversion may be performed in all or in part by the legacy property systems extractor.

In Step 611, the real estate property records are stored in the property data repository in accordance with one or more embodiments of the invention. Storing the property records may include creating a new record in the data repository and copying the property record onto the storage device of the data repository. By storing the property records in the data repository, the property records are ready for fast processing when the multiple properties mode is used.

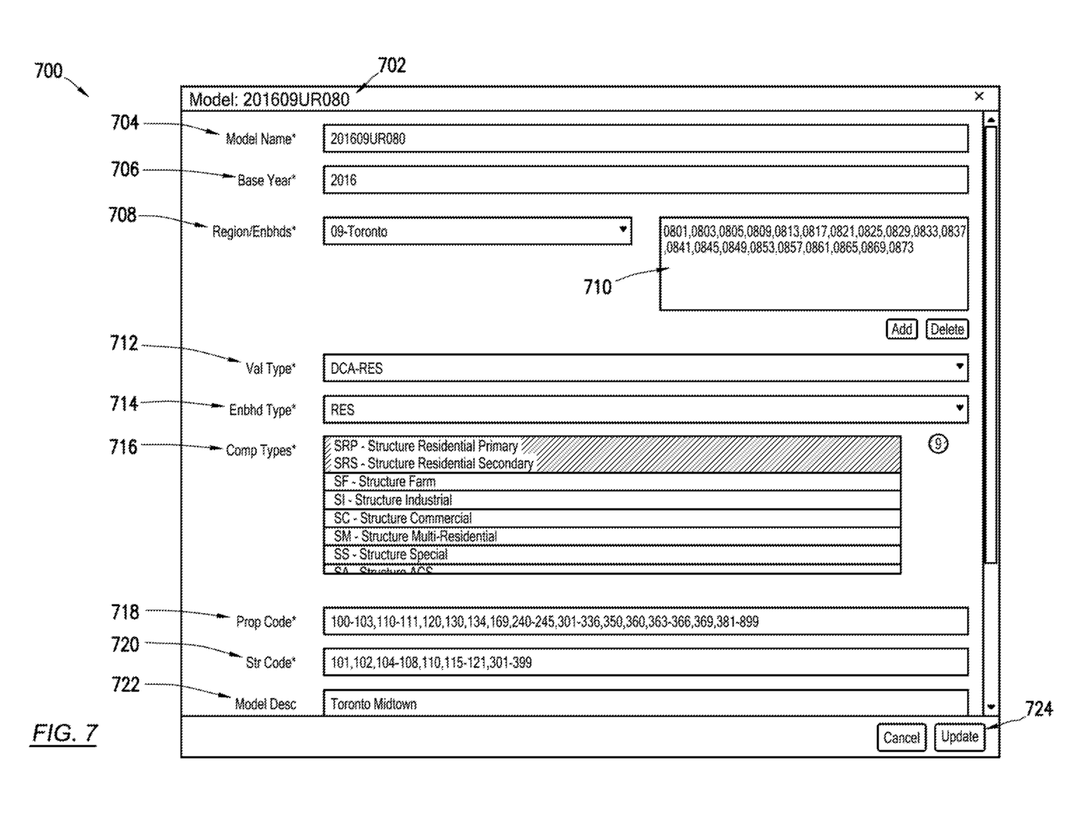

FIG. 7 shows an example of a user interface (700) for mapping a valuation model and data preparation code to attributes in the valuation tree in accordance with one or more embodiments of the invention. The following example is for explanatory purposes only and not intended to limit the scope of the invention.

As shown in FIG. 7, a user may specify a model name (704) that provides a unique identifier of the valuation model and may be displayed in the header (702) of the user interface. Further, the interface includes functionality to receive a base year (706) to which the valuation model is to be applied. The base year may specify the year for which the valuation is to be performed, or the year in which the point in time of the state and condition is a standard reference. For example, the base year may be that the valuation is a snapshot of the state and condition on the first day of January in the base year, which may be once every four years or as defined by applicable government rules. In other words, because values of properties may change in different years, the valuation model may also change. The user may also define attributes of properties which should use the model such as one or more regions (708) and sub-regions (710), a type of target property that is to be valued using the model (714), one or more codes describing the property (718), street codes (720) describing the environment in which the property is located, and other information. The various attributes of the target property may be used as selection criteria to select the corresponding model. In one or more embodiments of the invention, the user interface (700) may also allow the user to specify the valuation type or methodology applied by the valuation model (712), types of comparable properties (716) to use in the valuation, and a description of the valuation model (722). When the user selects the update button (724), the valuation tree is populated using the data from the user interface. Thus, the valuation tree may be updated to use additional valuation models.

Continuing with the example, the user may also create, delete, and/or edit data preparation code and valuation models. For example, the property valuation framework may include a webpage displaying a table that interrelates the names of the data preparation code, the author, date modified, size, and current version of the data preparation code. From the table, the user may select a user interface widget, such as a button to edit, download, or delete the data preparation code. The user interface may also include a widget to upload a new version of an existing code, execute the data preparation code, and perform other actions. Similarly, by way of another example, the property valuation framework may include a webpage displaying a table that interrelates the names of the valuation model, the author, date modified, size, and current version of the valuation model. From the table, the user may select a user interface widget, such as a button to edit, download, or delete the valuation model. The user interface may also include a widget to upload a new version of an existing valuation model, execute the valuation model, and perform other actions. In some embodiments, the user interface is configured to receive an equation form of the valuation model from the user, whereby the equation form is converted by the valuation framework into code (e.g., an executable or a script). In some embodiments, the user interface is configured to receive code form of the valuation model. For example, the user interface may include a code editor and/or an equation editor.

The following are examples of the various data items passed between components in accordance with one or more embodiments of the invention. The following examples are for example purposes only and not intended to limit the scope of the invention. In the examples, three consecutive dots (i.e., “ . . . ”) means some additional information may exist.

The below (entitled, “Example Excerpt 1”) is an example excerpt of the converted property data generated by the data format converter. As shown, the converted property data includes attributes of the property and attributes of the appraisal.

EXCERPT 1: CONVERTED PROPERTY DATA

```
{
    “residentialStructures”: [
        {
            “totalHeight”: null,
            “heatingSystemTypeCode”: “FA”,
            “sequenceNum”: 1,
            “priority4MethodCode”: “L”,
            “actualYearBuilt”: 1978,
            “structureConditionCode”: “A”,
            “replacementCostNew”: 41206,
            “costModelRequired”: “Y”,
            “totalBasementArea”: 1327,
            “structureCodeQualifierDescription”: null,
            “splitLevelTypeDescription”: “No Split”,
            “finishedBasementArea”: 424,
            “structureLength”: null,
            “uffiDescription”: “Urea Formaldehyde Foam Insulation
is not present”,
            “totalFloorArea”: 1393,
            “totalFirePlacesCount”: 0,
            “totalHeightUom”: null,
            “extraOversizeStorageLockersCount”: 0,
            “adjustmentPercentageReasonCode”: null,
            “valueComponentFlag”: “Y”,
            “designType”: [
                {
                    “code”: “N”,
                    “description”: “Not Defined”,
                    “ipsStructureId”: 2270414
                }
            ],
            “basementTypeCode”: “2”,
            “enclosedPorchArea”: 0,
            “doorSquareArea”: null,
            “structureUnit”: null,
            “additive”: 0,
            “winterizedCode”: “Y”,
            “amenityPoints”: null,
            “adjustmentPercentage”: 100,
            “garageTypeCode”: null,
            “totalBathsCount”: 1,
            “partStoreysDescription”: “No part storey”,
            “structureDescription”: “SINGLE FAMILY DETACHED”,
            “constructionCharacterDescription”: “Masonry
Construction”,
            “totalFullStoreysCount”: 1,
            “finishedBasementAreaUom”: “F”
            “splitLevelTypeCode”: “N”
            “exteriorTypeDescription”: null,
            “structureLengthUom”: null,
            “inPlaceCost”: “N”,
            “partStoreysCode”: “0”,
            “insulationDescription”: null,
            “modifications”: [ ],
            “basementHeightArea”: 8,
            “variables”: [ ],
...
            “insulationCode”: null,
            “deleteFlag”: “N”
            “amenityCode”: null,
            “airConditioningFlag”: “N”,
            “doorSquareAreaUom”: null,
...
            “actualYearBuiltCode”: “N”
        }
    ],
    “addressMailing”: {
        “streetNumberSuffixCode”: null,
        “deliveryInstallationTypeCode”: null,
        “foreignAddress4”: null,
        “poll”: “013”,
        “ward”: “00”,
        “foreignAddress1”: null,
        “unitDesignatorCode”: null,
        “suffix”: “0”,
        “upperStreetNumber”: null,
        “foreignAddress3”: null,
...
        “deliveryModeNum”: null,
        “languageIndicator”: “E”,
        “provinceStateCode”: “ON”,
        “validAddressFlag”: “Y”,
        “countryName”: “CAN”,
        “deliveryInstallationQualifier”: null,
        “streetTypeCode”: null
    },
    “addressPhysical”: {
        “addressLocationTypeCode”: “C”,
...
        “validParseFlag”: “Y”,
        “streetTypeCode”: null
    },
    “propertyValue”: {
        “systemAssessmentValue”: 224015.03,
        “realtyReasonDesc”: null,
        “suppOmitValue”: 0,
        “adjustedSystemAssessmentValue”: 212814.28,
        “authorityCode”: null,
        “directMarketEntryCode”: “N”
        “assessmentValue”: 212000,
        “nonAdjustedComponentValue”: 224015.03,
        “roundedAssessmentValue”: 212000,
        “realtyReasonCode”: null
    },
    “farmLands”: [ ],
    “eventType”: “CMV”,
    “propertyData”: {
        “rollCreateDate”: “1979-07-07 00:00:00.0”,
        “municipalityDescription”: “POWASSAN MUNICIPALITY”,
        “ipsPropertyId”: 1316329,
        “legalDescription”: “PLAN 946 LOT 9”,
        “propertyCodeDescription”: “Single-family detached (not on
water)”,
        “propertyStatus”: “A”,
...
            ],
            “conservationLandUom”: null,
            “actualDepthSys”: 124.7,
            “actualDepthUom”: “F”,
            “landAreaUom”: “F”,
            “landModelType”: null,
            “effectiveDepth”: 124.7
        }
    ],
    “metaData”: {
        “ipsLastModified”: “2014-11-10 04:08:18”,
        “version”: 2
    },
    “site”: {
        “effectiveLotSizeSys”: 0.17176308539944887,
        “unitClassDescription”: “Residential Unit”,
        “waterHookupSiteQuantity”: null,
        “waterServiceCode”: “M”,
        “drivewayTypeDescription”: “Separate or Private Driveway”,
        “farmLandClimateZone”: 0,
        “clrGradingRoadDevSiteCode”: null,
        “actualFrontageUom”: “F”,
        “onsite”: [
            {
                “code”: “C”,
                “description”: “CORNER LOT”,
                “VariableTypeCode”: “O”,
                “ipsPropertyId”: 1316329
            },
...
            }
        ],
        “neighbourhood”: {
            “farmLocational”: null,
            “farmHomogeneous”: null,
            “nonResLocational”: null,
            “resLocational”: “0064”,
            “resHomogeneous”: “M07”,
            “condominiumHomogeneous”: null,
            “nonResHomogeneous”: null,
            “condominiumLocational”: null
        },
        “farmLands”: [ ]
    }
}
```

The below (entitled, “Example Excerpt 2”) is an example excerpt of the valuation tree.

EXAMPLE EXCERPT 2: VALUATION TREE

```
{
    “valType”: “COST-RES”,
    “scriptCode”: “res_dpm.py”,
    “scriptLabel”: “PREP: Residential/Farm Application”,
    “applicationAudit”: true,
    “compTypes”: [
        “SRP”,
        “SRS”
    ],
    “author”: “dyckru”,
    “structureCodes”: [
        100,
        101,
        102,
...
        395,
        396,
        397,
        398,
        399
    ],
    “invalidSalesListing”: true,
    “softDelete”: false,
    “baseYear”: “2016”,
    “locations”: [
        {
            “region”: “00”,
            “enbhds”: [ ]
        }
    ],
    “propertyCodes”: [ ],
    “modelDescription”: null,
    “enbhdType”: “ALL”,
    “modelType”: “standard”,
    “lastModified”: 1433179607390,
    “compareToPrevious”: true,
    “model”: “201600RC010”,
    “id”: “550ae4f78ec2f432286e83ed”
}
{
    “scriptCode”: “res_dpm.py”,
    “scriptLabel”: “Residential/Farm Model Application”,
    “applicationAudit”: true,
    “compTypes”: [
        “LR”,
        “SRP”,
        “SRS”
    ],
    “author”: “mcintolu”,
    “structureCodes”: [
        101,
        102,
        104,
        105,
        106,
...
        397,
        398,
        399
    ],
    “invalidSalesListing”: true,
    “softDelete”: false,
    “baseYear”: “2016”,
    “locations”: [
        {
            “region”: “25”,
            “enbhds”: [
                “0060”,
                “0061”,
                “0062”,
...
                “0174”,
                “0175”
            ]
        }
    ],
    “propertyCodes”: [
        100,
        101,
        102,
        103,
        110,
...
        898,
        899
    ],
    “id”: “550ae4fe8ec2f432286e8470”,
    “enbhdType”: “RES”,
    “modelType”: “standard”,
    “lastModified”: 1413468858,
    “compareToPrevious”: true,
    “model”: “201625UR010”,
    “valType”: “DCA-RES”,
    “description”: “Model Description”
}
```

The below (entitled, “Example Excerpt 3”) is an example excerpt of the key value pair produced by executing the data preparation code on the property data. As shown in the example, transforms each attribute name into a short key that may be a variable name in the valuation model, and the attribute values into a numeric value that may be used directly as the variable value when applying the valuation model.

Further, information from the attributes may be transformed in the data preparation code. For example, an attribute specifying the year in which a building is built may be transformed into at least one key value pair where the key is the building is built more than thirty years ago and the value is a one or a zero, where one is more than thirty years and a zero is less than thirty years. The same attribute may be used to populate multiple key value pairs. The population of the attribute may be based on a mapping defined in the data preparation code. Thus, a one to one mapping, one to many mapping, many to one mapping, and many to many mapping may exist between attributes and key value pairs.

EXAMPLE EXCERPT 3: KEY VALUE PAIRS

```
{
    “acs_dpm”: [ ],
    “res_dpm”: [
        {
            “t1barna5”: 0,
            “t1barna4”: 0,
            “t1barna6”: 0,
            “cbn3cond”: “0”,
            “landlocked”: 0,
            “plan_applied_rezone”: 0,
...
            “t3barna”: 0,
            “pooliara”: 0,
            “wrkrs3_5a2”: 0,
            “wrkrs3_5a1”: 0,
            “baths”: 1,
            “cbn10eyb”: 0,
            “sh_weedy”: 0,
            “gardera2_5”: 0,
            “cbn5_5eyb”: 0,
            “unit_comland”: 0,
            “bhr6cond”: “0”,
            “tepcond”: “0”,
            “cbn6_5cond”: “0”,
            “cmpgrnd_dev_site”: “0”,
            “wrk2_5eyb”: 0,
...
            “cbn1_5cond”: “0”,
            “fp_type3”: 0,
            “pr_campg”: 0,
            “fp_type1”: 0,
            “trans_bus”: 0,
            “view_wf”: 0,
            “rcnld_of”: 0,
            “winter_s”: 0,
            “winter_p”: 1,
            “cbnarea2_5”: 0,
            “renoyear_a”: 0,
            “renoyear_b”: 0,
            “renoyear_c”: 0,
            “bth110a6_5”: 0
        }
    ]
}
```

Once the transformation is performed by the data preparer, the key value pairs may be submitted to the analytical model executor to execute the valuation models defined by the valuation tree for the property. Below (entitled, “Example Excerpt 4”) is an example excerpt of the valuation results received from the analytical model executor executing the analytical model.

EXAMPLE EXCERPT 4: INITIAL VALUATION RESULTS

```
[
    {
        “modelName”: “201600RC010”,
        “modelVersion”: 0,
        “valuationType”: “cost-res”,
        “rollNumber”: “425903002511230”,
        “propertyCode”: 301,
        “buildingIdNumber”: 1,
        “occupancyCode”: “0”,
        “parentId”: 0,
        “structureCode”: 301,
        “componentType”: “srp”,
        “componentId”: 2270414,
        “predictType”: “mv”,
        “predictValue”: 101023.037169184,
        “info”: {
            “inplacecost”: “n”,
            “rcn”: “42096.2264481486”,
            “enbhd_res”: “64”,
            “enbhd_fm”: “0”,
            “enbhd_nr”: “0”,
            “hnbhd_res”: “m07”,
            “hnbhd_fm”: “0”,
            “hnbhd_nr”: “0”,
            “lotsize”: “0.1717630854”,
            “frontage”: “60”,
            “depth”: “124.7”,
            “eff_ltsz”: “0.1717630854”,
            “comp_lotsize”: “0”,
            “comp_cl_ltsz”: “0”,
            “comp_mf_ltsz”: “0”,
            “comp_ex_ltsz”: “0”,
            “eff_fr”: “60”,
            “eff_dp”: “124.7”,
            “quality”: “6”,
            “area_tot”: “1393”,
            “yr_blt”: “1978”,
            “yrblteff”: “1978”,
            “cva_current”: “212000”,
            “sys_cva_current”: “224015.03”,
            “na_cva_current”: “224015.03”
        },
        “variablesUsed”: [
            {
                “name”: “heatcost”,
                “value”: 1393,
                “nesting”: 0,
                “total”: 1393,
                “coef”: 1,
                “label”: “Heatcost”
            },
...
            {
                “name”: “rcnld”,
                “value”: 101023.037169184,
                “nesting”: 0,
                “total”: 101023.037169184,
                “coef”: 1,
                “label”: “Rcnld”
            }
        ]
    },
    {
        “modelName”: “201600RC010”,
        “modelVersion”: 0,
        “valuationType”: “cost-res”,
        “rollNumber”: “425903002511230”,
        “propertyCode”: 301,
        “buildingIdNumber”: 2,
        “occupancyCode”: “0”,
        “parentId”: 0,
        “structureCode”: 121,
        “componentType”: “srs”,
        “componentId”: 2270415,
        “predictType”: “mv”,
        “predictValue”: 2968.83981638898,
        “info”: {
            “inplacecost”: “n”,
            “rcn”: “1200”,
            “enbhd_res”: “64”,
            “enbhd_fm”: “0”,
            “enbhd_nr”: “0”,
            “hnbhd_res”: “m07”,
            “hnbhd_fm”: “0”,
            “hnbhd_nr”: “0”,
            “lotsize”: “0.1717630854”,
            “frontage”: “60”,
            “depth”: “124.7”,
            “eff_ltsz”: “0.1717630854”,
            “comp_lotsize”: “0”,
            “comp_cl_ltsz”: “0”,
            “comp_mf_ltsz”: “0”,
            “comp_ex_ltsz”: “0”,
            “eff_fr”: “60”,
            “eff_dp”: “124.7”,
            “quality”: “3”
            “area_tot”: “510”,
            “yr_blt”: “1978”,
            “yrblteff”: “1978”,
            “cva_current”: “212000”,
            “sys_cva_current”: “224015.03”,
            “na_cva_current”: “224015.03”
        },
        “variablesUsed”: [
            {
                “name”: “bsmtgaragecost”,
                “value”: 1200,
                “nesting”: 0,
                “total”: 1200,
                “coef”: 1,
                “label”: “Bsmtgaragecost”
            },
            {
                “name”: “rcn”,
                “value”: 1200,
                “nesting”: 0,
                “total”: 1200,
                “coef”: 1,
                “label”: “Rcn”
            },
...
            {
                “name”: “rcnld”,
                “value”: 2968.83981638898,
                “nesting”: 0,
                “total”: 2968.83981638898,
                “coef”: 1,
                “label”: “Rcnld”
            }
        ]
    },
...
    {
        “modelName”: “201625UR010”,
        “modelVersion”: 0,
        “valuationType”: “dca-res”,
        “rollNumber”: “425903002511230”,
        “propertyCode”: 301,
        “buildingIdNumber”: 1,
        “occupancyCode”: “0”,
        “parentId”: 0,
        “structureCode”: 0,
        “componentType”: “lr”,
        “componentId”: 3124181,
        “predictType”: “mv”,
        “predictValue”: 125795.61650659,
        “info”: {
            “enbhd_res”: “64”,
            “enbhd_fm”: “0”,
            “enbhd_nr”: “0”,
            “hnbhd_res”: “m07”,
            “hnbhd_fm”: “0”,
            “hnbhd_nr”: “0”,
            “lotsize”: “0.1717630854”,
            “frontage”: “60”,
            “depth”: “124.7”,
            “eff_ltsz”: “0.1717630854”,
            “comp_lotsize”: “0.1717630854”,
            “comp_cl_ltsz”: “0”,
            “comp_mf_ltsz”: “0”,
            “comp_ex_ltsz”: “0”,
            “eff_fr”: “60”,
            “eff_dp”: “124.7”,
            “quality”: “0”,
            “area_tot”: “0”,
            “yr_blt”: “0”,
            “yrblteff”: “0”,
            “cva_current”: “212000”,
            “sys_cva_current”: “224015.03”,
            “na_cva_current”: “224015.03”
        },
        “variablesUsed”: [
            {
                “name”: “sqrt_elcd”,
                “value”: 9174.14944287861,
                “nesting”: 0,
                “total”: 11648.9679965895,
                “coef”: 1.26976,
                “equation_eval”: “sqrt(43560 *
0.1717630854(eff_ltsz)) * (11249/sqrt(11249)) * 1(landc) + sqrt(43560 *
0.1717630854(eff_ltsz)) * (13094/sqrt(13094)) * 0(landd)”,
                “label”: “Lot Size Adjustment”
            },
            {
                “name”: “intercpt”,
                “value”: 1,
                “nesting”: 0,
                “total”: 90731.54436,
                “coef”: 90731.54436,
                “label”: “Base Value”
            },
            {
                “name”: “nb064”,
                “value”: 1,
                “nesting”: 0,
                “total”: 23415.10415,
                “coef”: 23415.10415,
                “label”: “Neighbourhood Adjustment”
            }
        ]
    }
]
```

The valuation results, with the total, information about each valuation model applied, time of valuation and other information may be stored in the valuation repository. Below (entitled, “Example Excerpt 5”) is an example excerpt of the valuation results.

EXAMPLE EXCERPT 5: VALUATION RESULTS
STORED IN VALUATION REPOSITORY

```
{
    “assessmentIn”: {
        “_id”: 345151,
        “timestamp”: “2015-08-20T18:31:33+0000”,
        “components”: [
            {
                “buildingIdNumber”: 1,
                “componentId”: 2270414,
                “componentType”: “srp”,
                “info”: {
                    “area_tot”: “1393”,
                    “comp_cl_ltsz”: “0”,
                    “comp_ex_ltsz”: “0”,
                    “comp_lotsize”: “0”,
                    “comp_mf_ltsz”: “0”,
                    “cva_current”: “212000”,
                    “depth”: “124.7”,
                    “eff_dp”: “124.7”,
                    “eff_fr”: “60”,
                    “eff_ltsz”: “0.1717630854”,
                    “enbhd_fm”: “0”,
                    “enbhd_nr”: “0”,
                    “enbhd_res”: “64”,
                    “frontage”: “60”,
                    “hnbhd_fm”: “0”,
                    “hnbhd_nr”: “0”,
                    “hnbhd_res”: “m07”,
                    “inplacecost”: “n”,
                    “lotsize”: “0.1717630854”,
                    “na_cva_current”: “224015.03”,
                    “quality”: “6”,
                    “rcn”: “42096.2264481486”,
                    “sys_cva_current”: “224015.03”,
                    “yr_bit”: “1978”,
                    “yrblteff”: “1978”
                },
                “jobId”: “8dc91948-51f7-4e30-9681-f38699e25b6a”,
                “modelName”: “201600RC010”,
                “modelVersion”: 0,
                “occupancyCode”: “0”,
                “parentId”: 0,
                “predictType”: “mv”,
                “predictValue”: 101023.037169184,
                “propertyCode”: 301,
                “rollNumber”: “425903002511230”,
                “structureCode”: 301,
                “valuationType”: “cost-res”,
                “variablesUsed”: [
                    {
                        “coef”: 1,
                        “label”: “Heatcost”,
                        “name”: “heatcost”,
                        “nesting”: 0,
                        “total”: 1393,
                        “value”: 1393
                    },
...
                    {
                        “coef”: 1,
                        “label”: “Calcgoodpct”,
                        “name”: “calcgoodpct”,
                        “nesting”: 0,
                        “total”: 70.6866622949756,
                        “value”: 70.6866622949756
                    },
                    {
                        “coef”: 1,
                        “label”: “Modifier”,
                        “name”: “modifier”,
                        “nesting”: 0,
                        “total”: 3.5,
                        “value”: 3.5
                    },
                    {
                        “coef”: 1,
                        “label”: “Rcnld”,
                        “name”: “rcnld”,
                        “nesting”: 0,
                        “total”: 101023.037169184,
                        “value”: 101023.037169184
                    }
                ]
            },
            {
                “buildingIdNumber”: 2,
                “componentId”: 2270415,
                “componentType”: “srs”,
                “info”: {
                    “area_tot”: “510”,
                    “comp_cl_ltsz”: “0”,
                    “comp_ex_ltsz”: “0”,
                    “comp_lotsize”: “0”,
                    “comp_mf_ltsz”: “0”,
                    “cva_current”: “212000”,
                    “depth”: “124.7”,
...
                    “hnbhd_res”: “m07”,
                    “inplacecost”: “n”,
                    “lotsize”: “0.1717630854”,
                    “na_cva_current”: “224015.03”,
                    “quality”: “3”,
                    “rcn”: “1200”,
                    “sys_cva_current”: “224015.03”,
                    “yr_blt”: “1978”,
                    “yrblteff”: “1978”
                },
                “jobId”: “8dc91948-51f7-4e30-9681-f38699e25b6a”,
...
                “modelName”: [
                    “201625UR010”
                ],
                “modelVersion”: 0,
                “occupancyCode”: “0”,
                “override”: “”,
                “parentId”: 0,
                “predictType”: “mv”,
                “predictValue”: 125795.61650659,
                “priority”: 999,
                “structureCode”: 0,
                “valuationType”: “0”,
                “variablesUsed”: [
                    {
                        “coef”: 1.26976,
                        “equation_eval”: “sqrt(43560 *
0.1717630854(eff_ltsz)) * (11249/sqrt(11249)) * 1(landc) + sqrt(43560 *
0.1717630854(eff_ltsz)) * (13094/sqrt(13094)) * 0(landd)”,
                        “label”: “Lot Size Adjustment”,
                        “name”: “sqrt_elcd”,
                        “nesting”: 0,
                        “total”: 11648.9679965895,
                        “value”: 9174.1494428786
                    },
                    {
                        “coef”: 90731.54436,
                        “label”: “Base Value”,
                        “name”: “intercpt”,
                        “nesting”: 0,
                        “total”: 90731.54436,
                        “value”: 1
                    },
                    {
                        “coef”: 23415.10415,
                        “label”: “Neighbourhood Adjustment”,
                        “name”: “nb064”,
                        “nesting”: 0,
                        “total”: 23415.10415,
                        “value”: 1
                    }
                ]
            }
        ],
        “totalRawValue”: 103991.876985573,
        “totalValue”: 103991.876985573,
        “totalValueRounded”: 103000
    }
}
```

Embodiments of the invention may be implemented on a set of computing systems. Any combination of mobile, desktop, server, embedded, or other types of hardware may be used. For example, as shown in FIG. 8, the computing system (800) may include one or more computer processor(s) (802), associated memory (804) (e.g., random access memory (RAM), cache memory, flash memory, etc.), one or more storage device(s) (806) (e.g., a hard disk, an optical drive such as a compact disk (CD) drive or digital versatile disk (DVD) drive, a flash memory stick, etc.), and numerous other elements and functionalities. The computer processor(s) (802) may be an integrated circuit for processing instructions. For example, the computer processor(s) may be one or more cores, or micro-cores of a processor. The computing system (800) may also include one or more input device(s) (810), such as a touchscreen, keyboard, mouse, microphone, touchpad, electronic pen, or any other type of input device. Further, the computing system (800) may include one or more output device(s) (808), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (800) may be connected to a network (812) (e.g., a local area network (LAN), a wide area network (WAN) such as the Internet, mobile network, or any other type of network) via a network interface connection (not shown). The input and output device(s) may be locally or remotely (e.g., via the network (812)) connected to the computer processor(s) (802), memory (804), and storage device(s) (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (800) may be located at a remote location and connected to the other elements over a network (812). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

Although the above is discussed with respect to real estate property, one or more embodiments may be applied to valuation of other types of property, such as other types of real or intellectual property. In such a scenario, the various forms of property information describes attributes of the property and similar property, such as type, similar property values, age, and other attributes describing the property with particularity.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for valuation in heterogeneous real property systems comprising:
extracting, from a first legacy property management system, a first legacy system property data defined for a target real estate property;
converting the first legacy system property data from a first legacy data format to a standardized format to obtain first converted property data;
transmitting the first converted property data to an orchestrator;
querying a valuation tree with a plurality of property attributes from the first converted property data to obtain a first valuation model;
applying the first valuation model to the first converted property data to obtain a first plurality of valuation results;
generating a first property value from the first plurality of valuation results;
appending the first property value to the first plurality of valuation results; and
storing the first plurality of valuation results with a real estate property identifier for the target real estate property.

2. The method of claim 1, further comprising:
receiving, by the orchestrator, selection criteria for selecting a plurality of real estate properties to value;
creating, by the orchestrator, a job to value the plurality of real estate properties;
querying, by the orchestrator, the valuation tree with the selection criteria to obtain a second valuation model and data preparation code;
sending, by the orchestrator, a request to an extractor to obtain real estate property records for the plurality of real estate properties;
receiving, from the extractor, a link to a first entry in an execution repository, the first entry comprising the plurality of real estate property records;
executing, by a data preparer, the data preparation code on the plurality of real estate property records according to the job to obtain a plurality of transformed real estate property records;
storing the plurality of transformed real estate property records in a second entry;
applying, using the second entry, the second valuation model to the plurality of transformed real estate property records to obtain a second plurality of valuation results;
generate, for each real estate property record, a second property value from the second plurality of valuation results;
append property value and valuation information to the second plurality of valuation results; and
storing the second plurality of valuation results.

3. The method of claim 2, further comprising:
returning a link to the second entry to the orchestrator; and
sending the link to the second entry to an analytical model executor.

4. The method of claim 1, further comprising:
appending, to the first plurality of valuation results, valuation information defining the first valuation model to obtain revised valuation results,
wherein the revised valuation results are stored.

5. The method of claim 1, wherein the first plurality of valuation results are stored in an entry, and wherein the method further comprises:
returning a link to the entry to the first legacy property management system.

6. The method of claim 1, further comprising:
querying, by the orchestrator, the valuation tree with the plurality of property attributes from the first converted property data to obtain a second valuation model; and
applying the second valuation model to the first converted property data to obtain the first plurality of valuation results, wherein the first plurality of valuation results from applying the first valuation model is merged with the first plurality of valuation results from applying the second valuation model.

7. The method of claim 1, further comprising:
querying, by the orchestrator, the valuation tree with the plurality of property attributes from the first converted property data to obtain a data preparation code;
sending, by the orchestrator, the data preparation code and first converted property data to a data preparer; and
executing the data preparation code on the first converted property data by the data preparer to obtain model specific key value pairs,
wherein the valuation model is applied using the model specific key value pairs.

8. The method of claim 1, further comprising:
extracting a second legacy system property data defined for the target real estate property from a second legacy property management system;
converting the second legacy system property data from a second legacy data format to the common format to obtain second converted property data; and
merging the first converted data with the second converted property data to obtain merged data,
wherein transmitting the first converted property data comprises transmitting the merged data to the orchestrator.

9. A system for valuation in heterogeneous real property systems comprising:
a computer processor;
a storage device storing a valuation tree comprising a plurality of valuation models; and
an orchestrator executing on the computer processor and for:
receiving converted property data for a target real estate property;
querying the valuation tree with a plurality of property attributes from the converted property data to obtain a first valuation model of the plurality of valuation models;
transmitting the converted property data and the first valuation model to an analytical model executor to obtain a first plurality of valuation results;
transmitting the first plurality of valuation results to a value data repository interface for storing in a value data repository;
receiving a link to the first plurality of valuation results; and
transmitting the link to a legacy property management system.

10. The system of claim 9, further comprising:
a data format converted for extracting, from the legacy property management system, a legacy system property data defined for the target real estate property from the legacy property management system;
converting the legacy system property data from a legacy data format to a standardized format to obtain the converted property data; and
transmitting the converted property data to the orchestrator.

11. The system of claim 9, further comprising:
the analytical model executor for:
applying the first valuation model to the first converted property data to obtain the first plurality of valuation results.

12. The system of claim 9, further comprising:
the value data repository for storing the first plurality of valuation results; and
the value data repository interface for:
generating a first property value from the first plurality of valuation results;
appending the first property value to the first plurality of valuation results; and
storing the first plurality of valuation results with a real estate property identifier for the target real estate property.

13. The system of claim 9, wherein the orchestrator is further for:
receiving selection criteria for selecting a plurality of real estate properties to value;
creating a job to value the plurality of real estate properties;
querying the valuation tree with the selection criteria to obtain a second valuation model and data preparation code;
sending a request to an extractor to obtain real estate property records for the plurality of real estate properties;
receiving, from the extractor, a link to a first entry in an execution repository, the first entry comprising the plurality of real estate property records;
receiving a link to a second entry from a data preparer, the second entry comprising a plurality of transformed real estate property records generated from the plurality of real estate property records;
transmitting the link to the second entry and the second model to the analytical model executor to obtain a second plurality of valuation results; and
transmitting the first plurality of valuation results to a value data repository interface for storing in a value data repository.

14. The system of claim 13, further comprising:
the data preparer for executing the data preparation code on the plurality of real estate property records according to the job to obtain the plurality of transformed real estate property records; and
storing the plurality of transformed real estate property records in a second entry.

15. A distributed computer system comprising a plurality of nodes, the plurality of nodes configured to execute a method for valuation in heterogeneous real property systems, the method comprising:
extracting, from a first legacy property management system, a first legacy system property data defined for a target real estate property;
converting the first legacy system property data from a first legacy data format to a standardized format to obtain first converted property data;
transmitting the first converted property data to an orchestrator;
querying, by the orchestrator, a valuation tree with a plurality of property attributes from the first converted property data to obtain a first valuation model;
applying the first valuation model to the first converted property data to obtain a first plurality of valuation results;
generating a first property value from the first plurality of valuation results;
appending the first property value to the first plurality of valuation results; and
storing the first plurality of valuation results with a real estate property identifier for the target real estate property.

16. The distributed computing system of claim 15, wherein the method further comprises:
receiving, by the orchestrator, selection criteria for selecting a plurality of real estate properties to value;
creating, by the orchestrator, a job to value the plurality of real estate properties;
querying the valuation tree with the selection criteria to obtain a second valuation model and data preparation code;
sending, by the orchestrator, a request to an extractor to obtain real estate property records for the plurality of real estate properties;
receiving, from the extractor, a link to a first entry in an execution repository, the first entry comprising the plurality of real estate property records;
executing, by a data preparer, the data preparation code on the plurality of real estate property records according to the job to obtain a plurality of transformed real estate property records;
storing the plurality of transformed real estate property records in a second entry;
applying, using the second entry, the second valuation model to the plurality of transformed real estate property records to obtain a second plurality of valuation results;
generate, for each real estate property record, a second property value from the second plurality of valuation results;
append property value and valuation information to the second plurality of valuation results; and
storing the second plurality of valuation results.

17. The distributed computing system of claim 15, wherein the method further comprises:
returning a link to the second entry to the orchestrator; and
sending the link to the second entry to an analytical model executor.

18. The distributed computing system of claim 15, wherein the method further comprises:
querying, by the orchestrator, the valuation tree with the plurality of property attributes from the first converted property data to obtain the second valuation model; and
applying the second valuation model to the first converted property data to obtain the first plurality of valuation results, wherein the first plurality of valuation results from applying the first valuation model is merged with the first plurality of valuation results from applying the second valuation model.

19. The distributed computing system of claim 15, wherein the method further comprises:
querying, by the orchestrator, the valuation tree with the plurality of property attributes from the first converted property data to obtain a data preparation code;
sending, by the orchestrator, the data preparation code and the first converted property data to a data preparer; and
executing the data preparation code on the first converted property data by the data preparer to obtain model specific key value pairs,
wherein the valuation model is applied using the model specific key value pairs.

20. The distributed computing system of claim 15, wherein the method further comprises:
extracting a second legacy system property data defined for the target real estate property from a second legacy property management system;
converting the second legacy system property data from a second legacy data format to the common format to obtain second converted property data; and
merging the first converted data with the second converted property data to obtain merged data,
wherein transmitting the first converted property data comprises transmitting the merged data to the orchestrator.
